(19) United States
(12) Patent Application Publication
(10) Pub. No.: US 2002/0142069 A1
(43) Pub. Date: Oct. 3, 2002

(54) Conditioner for bread

(76) Inventor: Ali A. Elmusa, Leawood, KS (US)

Correspondence Address: STEVEN R. LUDWIG, STERNE, KESSLER, GOLDSTEIN & FOX P.L.L.C., 1100 NEW YORK AVENUE, N.W., SUITE 600, WASHINGTON, DC, 20005-3934, US

(21) Appl. No.: 10/013,831

(22) Filed: Dec. 13, 2001

Related U.S. Application Data
(60) Provisional application No. 60/265,122, filed on Jan. 31, 2001.

(51) Int. Cl. A23K 1/00

(52) U.S. Cl. 426/52

(57) ABSTRACT

The present invention relates to a bread conditioner comprising an isolated soy protein. The bread conditioner can further comprise xylanase, sodium stearoyl lactylate, ascorbic acid, fungal alpha amylase, cellulase, and azodicarbonamide. Another aspect of the present invention relates to a dough composition comprising a bread conditioner, which results in a loaf of bread containing at least 6.25 grams of soy protein per 50 gram serving of bread.

### BACKGROUND OF THE INVENTION

1. Field of the Invention

This invention generally relates to a bread conditioner comprising an isolated soy protein and various enzymes. This invention further relates to a dough comprising a bread conditioner that provides at least 6.25 grams of soy protein per 50 gram serving of bread.

2. Background Art

The nutritional benefits of soy have long been recognized, as soy is rich in various antioxidants, dietary fiber, and certain minerals and vitamins. There is a particular interest in soy protein because of its ability to lower cholesterol and reduce the risk of cardiovascular health risks.

On Oct. 20, 1999, the FDA announced its approval of a health claim based on the association between consumption of soy protein and a reduced risk of coronary heart disease. To qualify for the health claim, a food must contain at least 6.25 grams of soy protein per “reference amount customarily consumed” (RACC). For bread, the RACC is a 50 gram serving. Thus, in the baking industry, it is desired to provide a bread containing at least 6.25 grams of soy protein per 50 gram serving.

For many years, soy protein products have been added in significantly lower quantities to grain-based foods, including many bakery product, specifically bread. Such additions of soy protein, however, have not resulted in the required 6.25 grams of soy protein per 50 gram serving. For example, U.S. Pat. No. 4,759,934 to Ferrara discloses a bread which is high in protein, however, contains less than two grams of soy protein per 50 gram serving.

Making a bread that will qualify for the soy protein health claim is not an easy task. Adding sufficient soy protein to qualify for the health claim, while continuing to maintain product quality, has been difficult because of the substantial amount of soy protein required. One way to increase the level of soy protein in bread is by incorporating soy protein isolates. However, one of the problems with using soy protein as a protein source, particularly when using soy protein isolates, is that soy tends to have a bitter taste. Additionally, soy products do not add significant strength to bread products. Previous attempts to make edible, saleable bread with 6.25 grams of soy protein per 50 gram serving have been unsuccessful. Thus, what is needed is a bread conditioner that will provide at least 6.25 grams of soy protein in a satisfactory loaf of bread while maintaining product quality, and providing a satisfactory and edible loaf of bread.

In the bread industry, it is known to add additives and/or conditioners to a bread dough that result in a bread having improved flavor, texture, volume and freshness. Enzymes have been particularly useful as bread conditioners, such as those described in U.S. Pat. No. 6,110,508 to Olesen et al., U.S. Pat. No. 6,039,982 to Wagner et al., U.S. Pat. No. 5,318,785 to DeStefanis and U.S. Pat. No. 5,232,719 to Lad et al.

However, using such known bread conditioners and additives, the desirable level of 6.25 grams of soy protein has not been attained in the production of an edible, satisfactory loaf of bread. Although, it is possible to reach the 6.25 gram soy protein objective by adding soy grits, soy isolate and soy concentrate to bread, the resulting bread has been inedible and unsaleable. Thus, a bread conditioner is desired that, through the use of a synergistic combination of soy protein, various enzyme strains, and other ingredients, will contribute strength and conditioning to a bread dough and achieve at least 6.25 grams of soy protein per 50 gram serving of bread in a satisfactory loaf of bread meeting size, weight, volume, grain and appearance criteria.

### BRIEF SUMMARY OF THE INVENTION

The present invention relates to a bread conditioner comprising an isolated soy protein and other ingredients, which can include xylanase, sodium stearoyl lactylate, ascorbic acid, fungal alpha amylase, cellulase, and an oxidant. This invention further relates to a bread product comprising a bread conditioner that contains at least 6.25 grams of soy protein per 50 gram serving of a satisfactory loaf of bread.

### DETAILED DESCRIPTION OF THE INVENTION

A preferred embodiment of the present invention is now described. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

One embodiment of the present invention is directed to a bread conditioner comprising an isolated soy protein. Isolated soy proteins allow a bread conditioner to supply significant amounts of soy protein to a bread dough. In a preferred embodiment, the isolated soy protein has a protein content higher than about 70 percent. In a more preferred embodiment, the isolated soy protein has a protein content between about 85 and 95 percent. In a most preferred embodiment, the isolated soy protein has a protein content of between about 87 and 92 percent. The isolated soy protein can also comprise fat, ash, moisture and carbohydrates. A preferred isolated soy protein is ARDEX F Dispersible, which is a commercially available isolated soy protein manufactured by Archer Daniels Midland Company, and has a protein content of about 90 percent. However, alternate isolated soy proteins having varying protein contents can be used, as would be apparent to one skilled in the relevant art.

In a preferred embodiment, the bread conditioner further comprises various enzyme strains and other ingredients which contribute strength, conditioning, texture, flavor, volume, and/or freshness when added to a bread dough. Preferably, the bread conditioner includes xylanase, which adds strength to the bread and increases the extensibility of the dough.

Conventionally, low concentrations of xylanase have been used in bread conditioners. However, using low concentrations of xylanase often creates an undesirable stickiness of the dough. In a preferred embodiment of the present invention, xylanase is added to the bread conditioner at a concentration level of about 750-2000 parts per million (ppm) based on the weight of wheat flour in a dough. More preferably, the xylanase has a concentration level of about 900-1300 ppm. In a most preferred embodiment, the xylanase has a concentration level of about 1050-1150 ppm. The use of xylanase in the bread conditioner of the present invention adds necessary strength and extensibility, while minimizing the stickiness of the dough. A preferred xylanase enzyme is VERON SPECIAL, which is a commercially available xylanase enzyme manufactured by Rohm Gmbh. However, alternate xylanase enzymes can be used at varying concentrations, as would be apparent to one skilled in the relevant art.

In a preferred embodiment, the bread conditioner of the present invention further comprises a sodium stearoyl lactylate (SSL). SSL acts as a strengthener. Preferably, SSL is added to the bread conditioner at a concentration level of about 2500-5000 ppm based on wheat flour. In a more preferred embodiment, SSL is added to the bread conditioner at a concentration level of about 3500-5000 ppm, and in a most preferred embodiment, SSL is added to the bread conditioner at a concentration level of about 4500-5000 ppm. A preferred SSL is PANIPLEX SK, which is a commercially available sodium stearoyl lactylate manufactured by Archer Daniels Midland Company. However, alternate sodium stearoyl lactylates can be used at varying concentrations, as would be apparent to one skilled in the relevant art.

In a preferred embodiment, the bread conditioner of the present invention further comprises a fungal alpha amylase. Alpha amylases are useful for providing sugars fermentable by yeast, and can attack long starch chains at random at their interior and dextrinize and liquefy starch. Starch dextrinization during early stages of baking results in an improved grain and a softer texture. Alpha amylases induce changes in dough characteristics, such as decreasing water absorption capacity, slackening the dough, and developing stickiness.

In a preferred embodiment, the fungal alpha amylase has a level of about 200-750 skb. More preferably, the fungal alpha amylase has a level of about 300-600 skb. In a most preferred embodiment, the fungal alpha amylase has a level of about 400-500 skb. The skb unit expresses the alpha-amylase activity as measured by the method of Sandstedt, Kneen and Blish described in Association of American Cereal Chemists, 8th Edition, reprinted 1990, Official method 22-01, and also described in Technical Bulletin No. 1024, U.S. Department of Agriculture. One skb unit is the amount of enzyme which at 30 degrees Celsius and under the other specified reaction conditions is capable of dextrinizing one gram of soluble starch in one hour. In a preferred embodiment, the fungal alpha amylase is CLARASE 40000, which is a commercially available fungal alpha amylase manufactured by Genencor International, Inc. However, alternate fungal alpha amylases can be used at varying skb levels, as would be apparent to one skilled in the relevant art.

In a preferred embodiment, the bread conditioner of the present invention further comprises cellulase. In a preferred embodiment, cellulase can be added to the bread conditioner at a concentration of about 50-200 ppm based on wheat flour. More preferably, cellulase can be added at a concentration of about 75-150 ppm. In a most preferred embodiment, cellulase can be added at a concentration of about 90-110 ppm. A preferred cellulase is VERON CP, which is a commercially available cellulase manufactured by Rohm Gmbh. However, alternate cellulases can be used at varying concentrations, as would be apparent to one skilled in the relevant art.

In a preferred embodiment, the bread conditioner of the present invention further comprises an oxidant, such as azodicarbonamide, calcium peroxide, potassium iodate, calcium iodate, potassium bromate, or calcium bromate. Oxidants help to relax the dough. In a preferred embodiment, azodicarbonamide is added to the bread conditioner at a concentration of less than about 45 ppm based on wheat flour. In a more preferred embodiment, azodicarbonamide is added to the bread conditioner at a concentration of about 20-45 ppm. In a most preferred embodiment, azodicarbonamide is added at a concentration of about 35-45 ppm. However, various oxidants can be provided at varying concentrations, as would be apparent to one skilled in the relevant art.

In a preferred embodiment, the bread conditioner of the present invention further comprises ascorbic acid. Ascorbic acid acts as a toughener and a strengthener. In a preferred embodiment, ascorbic acid is added to the bread conditioner at a concentration of about 175-300 ppm based on wheat flour. More preferably, ascorbic acid can be added at a concentration of about 250-300 ppm. In a most preferred embodiment, ascorbic acid can be added at a concentration of about 270-290 ppm. In alternate embodiments, ascorbic acid can be provided at varying concentrations, as would be apparent to one skilled in the relevant art.

Thus, in a preferred embodiment, a bread conditioner of the present invention, which is to be added to a dough containing 250 pounds of wheat flour, can have the following composition:

BREAD CONDITIONER

| Ingredients | Percent weight of the bread conditioner |
|---|---|
| Isolated soy protein (dispersible | 96.514% |
| ARDEX F, about 90% protein) | |
| Sodium Stearoyl lactylate | 2.630% |
| (PANIPLEX SK) | |
| Xylanase (VERON SPECIAL) | 0.580% |
| Ascorbic Acid | 0.147% |
| Fungal alpha amylase | 0.060% |
| (CLARASE 40000) | |
| Cellulase (VERON CP) | 0.048% |
| Azodicarbonamide | 0.021% |

The bread conditioner of the present invention is preferably added to a dough composition which will result in a bread that contains at least 6.25 grams of soy protein per 50 gram serving of bread. This preferred bread conditioner adds about two grams of soy protein to a 50 gram serving of bread, while providing a carrier for the other ingredients in the bread dough, and further providing strength, conditioning, texture, flavor, volume, and/or freshness to the bread dough. The bread conditioner can be prepared by mixing or blending the ingredients. In alternate embodiments, the bread conditioner of the present invention can comprise further enzymes and ingredients, as would be apparent to one skilled in the relevant art.

Another aspect of the present invention relates to a dough for making bread which provides at least 6.25 grams of soy protein per 50 gram serving of bread. In a preferred embodiment, the dough comprises the bread conditioner of the present invention. The bread conditioner of the present invention allows the dough to provide an edible and satisfactory loaf of bread while attaining 6.25 grams of soy protein per serving. In addition to the bread conditioner, the dough composition of the present invention can further comprise one or more of the following ingredients: gluten, wheat flour, soy flour, grits, soy grits, water, oil, salt, honey, calcium propionate, ELASDO (a dough improver which is commercially available from Archer Daniels Midland Company), and yeast.

As discussed above, the bread conditioner of the present invention preferably provides about two grams of soy protein per fifty gram serving of bread. In a preferred embodiment, soy flour and soy grits can be added to the dough to enable the resulting loaf of bread to attain at least 6.25 grams of soy protein per 50 gram serving.

Preferably, the bread conditioner is pre-mixed, then added to the dough composition in order to produce a loaf of bread. The handling of the dough and baking of the bread can be done in any suitable manner, as would be apparent to one skilled in the relevant art. For example, the dough can be kneaded, then subjected to one or more proofing treatments, and then baked at a suitable temperature for a sufficient period of time.

In a preferred embodiment, the bread conditioner is added to the following dough composition, which results in a loaf bread containing at least 6.25 grams of soy protein per 50 gram serving:

BREAD COMPOSITION

| Ingredients | Weight in pounds |
|---|---|
| Flour | 250 |
| Soy Flour | 41 |
| Bread Conditioner | 47.5 |
| Gluten | 30 |
| Soy grits | 75 |
| Water | 400 |
| | (300 lbs added initially, 25 lbs added |
| | later, plus 75 lbs soaked with the grits) |
| Oil | 8 |
| Salt | 8 |
| Honey | 30 |
| Calcium Propionate | 2 |
| ELASDO | 2 |
| Yeast | 14 |

In a preferred embodiment, the soy grits are soaked for 10-15 minutes prior to being added to the mixer, and should not be oversoaked. In the above composition, 75 pounds of water are used to soak the 75 pounds of soy grits. The ingredients, without the soy grits, can mixed at a temperature of 78-80 degrees Fahrenheit for 30 seconds on low and 11 minutes on high. In a preferred embodiment, 25 pounds of the water is held back, and added after 5 minutes of mixing. Next, the soy grits can be added, and the bread conditioner can be mixed for an additional 2 minutes on high. In a preferred embodiment, the proof time can be about 50 minutes. The proof time can be longer if less yeast is to be used in the dough composition. The bread should be baked for a suitable time. For example, the bread can be baked at about 400 degrees Fahrenheit for about thirty minutes. In a preferred embodiment, the soy bread composition can be baked in a 3″×4¾″×10¾″ pan. Alternate proof times, baking times, baking temperatures, and pan sizes can be used, as would be apparent to one skilled in the relevant art.

Further, the conditioner of the present invention can be used with other baked products such as rolls, taco shells, tortillas, cakes, breakfast rolls, muffins, pancakes, cereal, health bars, soft pretzels, and pasta.

While the invention has been particularly shown and described with reference to preferred embodiments thereof, it will be understood by those skilled in the art that they have been presented by way of example only, and not limitation, and various changes in form and details can be made therein without departing from the spirit and scope of the invention. Thus, the breadth and scope of the present invention should not be limited by any of the above-described exemplary embodiments, but should be defined only in accordance with the following claims and their equivalents. Additionally, all references cited herein, including journal articles or abstracts, published or corresponding U.S. or foreign patent applications, issued U.S. or foreign patents, or any other references, are each entirely incorporated by reference herein, including all data, tables, figures, and text presented in the cited references.

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one of ordinary skill in the art.

What is claimed is:

1. A conditioner for bread, comprising an isolated soy protein and xylanase.

2. The conditioner of claim 1, wherein said isolated soy protein has a protein content greater than about 70 percent.

3. The conditioner of claim 1, wherein said isolated soy protein has a protein content of about 85 to about 95 percent.

4. The conditioner of claim 1, wherein said xylanase has a concentration level of about 750 ppm to about 2000 ppm.

5. The conditioner of claim 1, wherein said isolated soy protein is about 90 percent to about 98 percent by weight of the conditioner.

6. The conditioner of claim 1, wherein said isolated soy protein is about 96 percent by weight of the conditioner.

7. The conditioner of claim 1, further comprising sodium stearoyl lactylate.

8. The conditioner of claim 7, wherein said sodium stearoyl lactylate has a concentration level of about 2500 ppm to about 5000 ppm.

9. The conditioner of claim 7, further comprising fungal alpha amylase.

10. The conditioner of claim 9, wherein said fungal alpha amylase is about 200 skb to about 750 skb.

11. The conditioner of claim 9, further comprising cellulase.

12. The conditioner of claim 11, wherein said cellulase has a concentration level of about 50 ppm to about 200 ppm.

13. The conditioner of claim 11, further comprising an oxidant selected from the group consisting of azodicarbonamide, calcium peroxide, potassium iodate, calcium iodate, potassium bromate, and calcium bromate.

14. The conditioner of claim 13, wherein said oxidant is azodicarbonamide having a concentration level of about 20 to 45 ppm.

15. The conditioner of claim 13, further comprising ascorbic acid.

16. The conditioner of claim 15, wherein said ascorbic acid has a concentration level of about 175 ppm to about 300 ppm.

17. A dough for producing bread which provides at least 6.25 grams of soy protein per 50 gram serving, comprising:
wheat flour;
water; and
a bread conditioner comprising isolated soy protein.

18. The dough of claim 17, further comprising soy flour.

19. The dough of claim 18, further comprising soy grits.

20. The dough of claim 19, further comprising gluten, grits, calcium propionate, and yeast.

21. The dough of claim 17, wherein said isolated soy protein has a protein content of about 85 to about 95 percent.

22. The dough of claim 21, wherein said isolated soy protein is about 90 percent to about 98 percent by weight of the conditioner.

23. The dough of claim 21, wherein said isolated soy protein is about 96 percent by weight of the conditioner.

24. The dough of claim 21, wherein said bread conditioner is about 19 percent by weight based upon the weight of said wheat flour.

25. The dough of claim 17, wherein said bread conditioner further comprises sodium stearoyl lactylate, xylanase, ascorbic acid, fungal alpha amylase, cellulase, and azodicarbonamide.

26. The dough of claim 25, wherein said bread conditioner further comprises:
about 96 percent isolated soy protein by weight of said conditioner;
about 2500 ppm to about 5000 ppm sodium stearoyl lactylate;
about 750 ppm to about 2000 ppm xylanase;
about 175 ppm to about 300 ppm ascorbic acid;
about 200 skb to about 750 skb fungal alpha amylase;
about 50 ppm to about 200 ppm cellulase; and
about 20 ppm to about 45 ppm azodicarbonamide.
